(19) United States
(12) Patent Application Publication
(10) Pub. No.: US 2022/0397237 A1
(43) Pub. Date: Dec. 15, 2022

(54) METHOD FOR PREPARING A HYDROGEN TANK COMPRISING A SEALING LAYER AND A BASE

(71) Applicant: ARKEMA FRANCE, Colombes (FR)

(72) Inventors: Nicolas DUFAURE, Serquigny (FR); Antoine GOUPIL, Seoul (KR); Olivier MERLE, Colombes Cedex (FR); Patrick DANG, Serquigny (FR)

(73) Assignee: ARKEMA FRANCE, Colombes (FR)

(21) Appl. No.: 17/776,380

(22) PCT Filed: Nov. 12, 2020
(86) PCT No.: PCT/FR2020/052058

§ 371 Date: May 12, 2022

(30) Foreign Application Priority Data
Nov. 14, 2019 (FR) 1912707

(51) Int. Cl. F17C 1/00

(52) U.S. Cl. CPC F17C 1/005; F17C 2203/0604; F17C 2203/0617; F17C 2203/0663; F17C 2203/0675; F17C 2209/2145; F17C 2209/227; F17C 2221/012; F17C 2203/066

(57) ABSTRACT

Method for preparing a hydrogen tank including at least one sealing layer of a composition including at least one polyamide P1, and at least one base in order to provide the tank with at least one opening, wherein the method includes: providing of at least one base, the at least one base being covered by at least one layer of a composition including at least one adhesion primer; preparing the at least one sealing layer; fastening the at least one base to the at least one sealing layer.

The present invention relates to a method for preparing a hydrogen tank comprising a sealing layer and a base.

Hydrogen tanks are currently attracting a lot of attention from numerous manufacturers, especially in the automotive sector. One of the goals sought is to propose increasingly fewer polluting vehicles. Thus, electric or hybrid vehicles comprising a battery aim to progressively replace combustion engine vehicles such as either gas or diesel vehicles. It has turned out that the battery is a relatively complex vehicle component. Depending on the positioning of the battery in the vehicle, it may be necessary to protect it from impact and from the outside environment, which can have extreme temperatures and variable humidity. It is also necessary to avoid any risk of flames.

Additionally, it is important that the operating temperature thereof not exceed 55° C. in order to not break down the cells of the battery and to preserve the life thereof. Conversely, for example in winter, it may be necessary to increase the battery temperature so as to optimize operation thereof.

Moreover, electric vehicles still suffer today from several problems, namely battery range, the use in these batteries of rare earth metals, the resources for which are not infinite, much longer recharging times than the length of time taken to fill a tank, as well as a problem of electricity production in various countries in order to be able to recharge the batteries.

Hydrogen is therefore an alternative to the electric battery, since hydrogen can be converted into electricity by means of a fuel cell and thus power electric vehicles.

Hydrogen tanks usually consist of a metallic liner (or sealing layer) that must prevent hydrogen from permeating out. One of the types of tank envisaged, referred to as Type IV, is based on a thermoplastic liner around which a composite is wound.

The permeability of the liner is a key factor in limiting hydrogen losses from the tank. Another zone has an important role in this permeability/leakage; the connection between the liner and the metal outlet (or base or boss) of the tank.

The first generation of type IV tanks uses a liner based on high-density polyethylene (HDPE). Liners based on polyamide PA6 have been in development for a number of years.

The metal/plastic connections are always difficult to achieve, particularly when there is a difference in pressure on either side of the zone being connected. This is the case for hydrogen tanks. The pressure inside the tank can reach 1000 bar. The pressure in the tank varies regularly and frequently between a few bar and several hundred bar, which results in significant deformation of the tank. Very significant and highly variable stresses are therefore applied to the liner and the base which ensures the continuity of the seal. The interface between these 2 parts is therefore subject to high stresses.

To resolve this problem, it is known to design the plastic liner with a circular protrusion located in the axial direction of the base and extending within the base up to the vicinity of an internal thread to tighten the valve. The valve is equipped with circumferential grooves housing a sealing O-ring.

Application EP0300931 discloses tanks for any fluid comprising an internal shell made from a thermoplastic material intended to achieve the seal and an external shell made by filament winding intended to ensure mechanical strength, with a cup interposed between the two shells.

However, there are risks of permeability and leaks around the O-ring which increase over time.

Application US2019/0170300 discloses a tank comprising a non-metal liner, notably made from polyamide, a reinforcement layer consisting of a composite material surrounding the liner, and a metal base coupled to the liner and the reinforcement layer, the base being connected to the liner by means of a co-molded polymer-metal annular connection zone without the presence of an elastomer seal.

Tank manufacturers substantially work on the design of this zone, and adhesion in this location must therefore be significantly improved, whilst maintaining the designs currently used, notably by increasing the adhesion between the liner and the boss.

One of the purposes of the invention is to provide a preparation method making it possible to increase the adhesion between the liner and the boss and thus to limit gas losses or leaks at the connection between the liner and the base or boss.

The present invention therefore relates to a method for preparing a hydrogen tank (1) comprising at least one sealing layer (2) consisting of a composition comprising at least one polyamide P1, and at least one base (3) to provide at least one opening (5) in said tank (1), characterized in that said method comprises:

Providing at least one base (3), said at least one base (3) being covered by at least one layer (a) consisting of a composition comprising at least one adhesion primer,

Preparing said at least one sealing layer (2),

Fastening said at least one base (3) to said at least one sealing layer (2), said base (3) being fastened to said sealing layer (2) during the preparation of said sealing layer (2) or after the preparation of said sealing layer (2).

The inventors unexpectedly found that covering the base with at least one layer (a) consisting of a composition comprising at least one adhesion primer, made it possible to securely join and therefore to increase the adhesion of the sealing layer (2) to the base (3), resulting in a better seal between said sealing layer (2) and the base (3) and reduced permeability and leaks at the connection (6) (or join (6)) between said sealing layer (2) and the base (3).

Regarding the Layer (a) Covering the Base (3)

The layer (a) consists of a composition comprising at least one adhesion primer.

The expression “adhesion primer” means a compound which, when applied to a support or substrate to be protected, in this case the base (3), and intended to receive a second support, in this case the sealing layer (2), makes it possible to reinforce the connection between the two supports and therefore to create a chemical and/or physical bond between the two supports resulting in strong adhesion between said substrate and said sealing layer (2) and thus making it possible to securely join and therefore increase the adhesion of the sealing layer (2) to the base, resulting in a better seal between said sealing layer (2) and said base (3).

Advantageously, said adhesion primer is in liquid or solid form, in particular in powder form, advantageously it is in liquid form.

When it is in powder form, the powder particles of said adhesion primer have a volume diameter of the powder particles is within the ratio D90/D10, that is from 1.5 to 50, advantageously from 2 to 10.

The volume diameters of the particles (D10, D50 and D90) are defined according to standard ISO 9276:2014.

The “D50” corresponds to the average diameter by volume, that is to say, the value of the particle size that divides the examined population of particles exactly in half.

The “D90” corresponds to the value at 90% of the cumulative curve of the particle size distribution by volume.

The “D10” corresponds to the corresponds to the size of 10% of the volume of the particles.

When it is in liquid form, it may be in aqueous or solvent-based solution.

Advantageously, said adhesion primer is selected from an epoxide, a combination of an epoxide, an ethyl silicate, an aromatic or aliphatic polyurethane, a polyamide P2 and a mixture thereof.

In one embodiment, said adhesion primer is selected from an aromatic or aliphatic polyurethane, an epoxide, a mixture of an aromatic or aliphatic polyurethane, and epoxide, and a mixture of a polyamide P2 and epoxide.

Advantageously, said adhesion primer is selected from an aromatic or aliphatic polyurethane, an epoxide, a mixture of an aromatic or aliphatic polyurethane and epoxide.

When the polyamide P2 is in a mixture with an epoxide, the mixture thus consists of epoxide particles dispersed in a powder of polyamide P2.

The epoxide particles in the epoxide-polyamide powder are present from 2 to 10% by weight.

The particles of epoxide and of polyamide P2 powder may have different median diameters D50 but advantageously the mixture of these two products has a volume median diameter D50 of from 3 to 300 μm, especially from 10 to 200 μm, more particularly from 15 to 150 μm.

The thickness of said adhesion primer covering the base (3) is from 1 μm to 200 μm.

Advantageously, it depends on the compound constituting the primer.

Thus, in the case of a single compound, for example an epoxide or a polyurethane, the thickness is from 1 μm to 30 μm, advantageously from 2 to 20 μm

When the compound consists of a mixture of polyurethane and epoxide, the thickness is then from 1 μm to 30 μm, advantageously from 2 to 20 μm.

When the compound consists of a mixture of a polyamide P2 and epoxide, the thickness is then from 10 μm to 300 μm, advantageously from 20 to 150 μm.

The liquid primer may be applied either by dipping into a primer bath, or by spraying, or even by using a brush.

The powder primer is, for its part, applied only by spraying and in the case where the primer is a mixture of polyamide P2 and epoxide or polyamide P2 and polyurethane, then the electrostatic powder coating method is preferred.

In one embodiment, the layer (a) consists of a composition comprising a single adhesion primer.

Advantageously, said adhesion primer is selected from an epoxide and an aromatic or aliphatic polyurethane, in particular an epoxide.

In one embodiment, said at least one adhesion primer is an epoxide or a mixture of polyester and epoxide, in particular an epoxide, and the thickness of the layer (a) is from 1 to 20 μm.

Advantageously, said at least one base (3) is metal and covered by at least one layer (a) consisting of a composition comprising at least one adhesion primer consisting of an epoxide.

Advantageously, the layer (a) consists of a composition consisting of a single adhesion primer.

In this latter case, said adhesion primer is selected from an epoxide and a polyurethane, in particular an epoxide.

In another embodiment, the layer (a) consists of a composition comprising an adhesion primer consisting of a mixture of polyamide P2 and epoxide or of polyamide P2 and polyurethane, in particular a mixture of polyamide P2 and epoxide.

Advantageously, the layer (a) consists of a composition consisting of an adhesion primer consisting of a mixture of polyamide P2 and epoxide or of polyamide P2 and polyurethane, in particular a mixture of polyamide P2 and epoxide.

In one embodiment, said at least one metal base (3) covered by at least one layer (a) consisting of a composition comprising at least one adhesion primer consisting of an epoxide is then covered by a layer (b) consisting of a composition comprising at least one polyamide P2 in powder form.

Advantageously, the layer consisting of a composition comprising at least one polyamide P2 has a thickness of from 50 μm to 1500 μm.

Said composition of the layer (a) may further comprise impact modifiers and/or additives.

The additives may be chosen from an antioxidant, a heat stabilizer, a UV absorber, a light stabilizer, a lubricant, an inorganic filler, a flame retardant agent, a nucleating agent, a plasticizer, and a dye.

Advantageously, said composition of the layer (a) predominantly consists of said polyamide P3j, from 0 to 5% by weight of impact modifier, from 0 to 5% by weight of additives, the sum of the constituents of the composition being equal to 100%.

Regarding the Base (3)

It may consist of any material compatible with said layer (a) and said sealing layer (2), especially plastic or metal.

Advantageously, it is metal, especially, without being limited thereto, made from steel, in particular stainless steel, cast iron and aluminum.

Advantageously, it is degreased and/or stripped/shot-peened before being covered by said at least one layer (a) consisting of a composition comprising at least one adhesion primer.

Degreasing is an essential step intended to eliminate greasy substances which build up on the surface of the metal part during its manufacture. It involves the use of alkaline, neutral or acidic products (depending on the nature of the grease to be eliminated and the nature of the metal). These products can be applied by spraying or immersion. More conventional solvent-based solutions (trichloroethylene, perchloroethylene) may also be used.

To eliminate the grease found on large steel (or iron alloy) parts, high temperature pyrolysis may be used when the metal structure so permits.

The stripping/shot-peening follows the degreasing step and aims to eliminate all the foreign bodies (particles of carbon or metal oxides) present on the surface of the part. Once the surface is free of any trace of oil or grease, the following method can be applied:

Mechanical stripping involves spraying an abrasive substrate onto the surface of the part. A G17 type angular cast iron grit or corundum is recommended for ferrous metals and an aluminum grit for aluminum-based alloys. The spraying air must be dry and free of any traces of oil. Once shot-peened, the part must be immediately coated (generating within eight hours) or can be temporarily stored away from moisture in order to prevent the appearance of oxides on the surface. If signs of surface corrosion appear, the shot-peening step must be repeated before the coating can be applied.

Chemical stripping involves the immersion into, or spraying onto the part, of strong acid solutions (sulfuric, hydrochloric or phosphoric acid), followed by successive rinsing and drying in stable and controlled chemical baths. Other types of chemical treatment (electrodeposition, phosphating, chromating, etc.) can be used if they are compatible with the coating, especially made of polyamide, and its method of application. High-quality shot-peening must produce a perfectly clean surface (Sa 2½-3) and a roughness (measured in accordance with standard ISO 4287-1:1997) especially of between 10 μm and 80 μm.

Optionally, a degassing step is carried out before the stripping/shot-peening.

Regarding Polyamide P1 of the Sealing Layer (2)

The sealing layer (2) consists of a composition comprising at least one polyamide P1.

Said composition may further comprise impact modifiers and/or additives.

The additives may be selected from an antioxidant, a heat stabilizer, a UV absorber, a light stabilizer, a lubricant, an inorganic filler, an organic filler, a flame retardant, a nucleating agent, a plasticizer, a pigment and a dye.

Advantageously, said composition predominantly consists of said polyamide P1, from 0 to 5% by weight of impact modifier, from 0 to 5% by weight of additives, the sum of the constituents of the composition being equal to 100%.

The nomenclature used to define the polyamides is described in ISO standard 1874-1:2011 “Plastiques—Matériaux polyamides (PA) pour moulage et extrusion—Partie 1: Designation”, especially on page 3 (Tables 1 and 2) and is well known to the person skilled in the art.

The polyamide may be a homopolyamide or a co-polyamide or a mixture thereof.

Advantageously, said polyamide is a semi-crystalline polyamide or copolyamide.

The expression “semi-crystalline”, within the meaning of the invention, denotes a (co)polyamide that has a melting temperature (Tm) by DSC according to ISO standard 11357-3:2013, and an enthalpy of crystallization during the cooling step at a rate of 20 K/min by DSC measured according to ISO standard 11357-3 of 2013 of greater than 20 J/g, preferably greater than 30 J/g.

In one embodiment, said polyamide P1 is a semi-aromatic co-polyamide comprising at least two distinct units A and XY of formula A/XY, wherein:

A is a repeating unit obtained by polycondensation:
of at least one C9 to C18, preferentially C10 to C18, more preferentially C10 to C12, amino acid, or
of at least one C9 to C18, preferentially C10 to C18, more preferentially C10 to C12, lactam, or
of at least one C4-C36, preferentially C6-C18, preferentially C6-C12, more preferentially C10-C12, Ca diamine, with at least one C4-C36, preferentially C6-C18, preferentially C6-C12, more preferentially C10-C12, Cb dicarboxylic acid,
XY is a repeating unit obtained from the polycondensation of at least one C9 to C18, preferentially C10 to C18, more preferentially C10 to C12, linear aliphatic diamine (X) and at least one aromatic dicarboxylic acid (Y),

When the repeating unit A of said copolyamide is obtained from the polycondensation of at least one lactam, said at least one lactam may be selected from a C9 to C18 lactam, preferentially C10 to C18, more preferentially C10 to C12. A C10 to C12 lactam is especially decanolactam, undecanolactam, and lauryllactam.

Said unit A is obtained from the polycondensation of at least one lactam and may therefore comprise a single lactam or several lactams.
Advantageously, said unit A is obtained from the polycondensation of a single lactam and said lactam is lauryllactam.
It would not go beyond the scope of the invention if said unit A was obtained from the anionic polymerization of the lauryllactam.

When the repeating unit A of said copolyamide is obtained from the polycondensation of at least one amino acid, said at least one amino acid can be selected from a C9 to C18, preferentially C10 to C18, more preferentially C10 to C12 amino acid.

A C9 to C12 amino acid is especially 9-aminononanoic acid, 10-aminodecanoic acid, 10-aminoundecanoic acid, 12-aminododecanoic acid and 11-aminoundecanoic acid and derivatives thereof, in particular N-heptyl-11-aminoundecanoic acid.
Said unit A is obtained from the polycondensation of at least one amino acid and may therefore comprise a single amino acid or several amino acids.

Advantageously, said unit A is obtained from the polycondensation of a single amino acid and said amino acid is 11-aminoundecanoic acid.

When the repeating unit A of said copolyamide is obtained from the polycondensation of at least one C4-C36, preferentially C6-C18, preferentially C6-C12, more preferentially C10-C12, Ca diamine with at least one C4-C36, preferentially C6-C18, preferentially C6-C12, more preferentially C10-C12, Cb diacid, then said at least one Ca diamine is a linear or branched, in particular linear, aliphatic diamine and said at least one Cb diacid is a linear or branched aliphatic diacid, in particular a linear diacid.

Advantageously, said at least one diamine is linear aliphatic and said at least one diacid is aliphatic and linear.

Said at least one C4-C36 Ca diamine can be in particular selected from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and the diamines obtained from fatty acids.

Advantageously, said at least one Ca diamine is C5-C18 and selected from 1,5-pentamethylenediamine, 1,6-hexamethylenediamine, 1,7-heptamethylenediamine, 1,8-octamethylenediamine, 1,9-nonamethylenediamine, 1,10-decamethylenediamine 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one C5 to C12 Ca diamine is in particular selected from 1,5-pentamethylenediamine, 1,6-hexamethylenediamine, 1,7-heptamethylediamine, 1,8-octamethylediamine, 1,9-nonamethylenediamine, 1,10-decamethylenediamine, 1,11-undecamethylenediamine, and 1,12-dodecamethylenediamine.

Advantageously, the Ca diamine used is a C10 to C12 diamine, in particular selected from 1,10-decamethylenediamine, 1,11-undecamethylenediamine, and 1,12-dodecamethylenediamine.

Said at least one C4 to C36 Cb dicarboxylic acid may be selected from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, octadecenediamine, eicosanediamine, docosanediamine and diamines obtained from fatty acids.

Advantageously, said at least one Cb dicarboxylic acid is C6 to C18 and is selected from adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid.

Advantageously, said at least one Cb dicarboxylic acid is C6 to C12 and is selected from adipic acid, suberic acid, azelaic acid, sebacic acid, undecanedioic acid, and dodecanedioic acid.

Advantageously, said at least one Cb dicarboxylic acid is C10 to C12 and is selected from sebacic acid, undecanedioic acid and dodecanedioic acid.

Said unit A is obtained from the polycondensation of at least one Ca diamine with at least one Cb dicarboxylic acid and may therefore comprise a single diamine or a plurality of diamines and a single dicarboxylic acid or several dicarboxylic acids.

Advantageously, said unit A is obtained from the polycondensation of a single CA diamine with a single Cb dicarboxylic acid.

Said unit XY is a repeating unit obtained from the polycondensation of at least one C9 to C18, preferentially C10 to C18, more preferentially C10 to C12, linear aliphatic diamine (X) and at least one aromatic dicarboxylic acid (Y).

Said linear aliphatic diamine (X) is as defined for said linear aliphatic Ca diamine.

Said linear aliphatic diamine (X) may be identical to or different from the linear aliphatic Ca diamine.

Said aromatic dicarboxylic acid (Y) may be C6 to C18, C6 to C18, preferentially C8 to C18, more preferentially C8 to C12.

Advantageously, it is chosen from terephthalic acid (T), isophthalic acid (I), or naphthalene dicarboxylic acid (N).

In an advantageous embodiment, said aromatic dicarboxylic acid (Y) is terephthalic acid.

Advantageously, said polyamide is a long chain semi-aromatic polyamide, that is to say a polyamide having an average number of carbon atoms per nitrogen atom greater than 8.5, preferably greater than 9.

Advantageously, the semi-aromatic polyamide is a polyamide selected from A/5T, A/6T, A/9T, A/10T, A/11T, A/12T and A/BACT, A being as defined above, in particular a polyamide selected from a PA MPMDT/6T, a PA11/10T, a PA 5T/10T, a PA 11/BACT, a PA 11/6T/10T, a PA MXDT/10T, a PA MPMDT/10T, a PA BACT/10T, a PA BACT/6T, PA BACT/10T/6T, a PA 11/BACT/6T, PA 11/MPMDT/6T, PA 11/MPMDT/10T, PA 11/BACT/10T, a PA 11/MXDT/10T, a 11/5T/10T.

T corresponds to terephthalic acid, MXD corresponds to m-xylylene diamine, MPMD corresponds to methylpentamethylene diamine and BAC corresponds to bis(aminomethyl)cyclohexane.

In another embodiment, said polyamide P1 is an aliphatic polyamide or an aliphatic copolyamide, in particular an aliphatic polyamide.

Advantageously, said thermoplastic polymer is a short chain aliphatic polyamide, that is to say a polyamide having an average number of carbon atoms per nitrogen atom of from 4 to 8.5, in particular from 4 to 7, or a long chain polyamide, that is to say a polyamide having an average number of carbon atoms per nitrogen atom greater than 8.5, preferably greater than 9.

In particular, the short chain aliphatic polyamide is polyamide 6 (PA6) and the long chain aliphatic polyamide is selected from polyamide 11 (PA11), polyamide 12 (PA12), polyamide 1010 (PA1010), polyamide 1012 (PA1012), polyamide 1212 (PA1012), or a mixture thereof or a copolyamide thereof, in particular PA11 and PA12.

Advantageously, said at least one aliphatic polyamide P1 is selected from PA6, PA11 and PA12.

Regarding Polyamide P2

Polyamide P2 is as defined for polyamide P1.

Advantageously, polyamide P2 is a long chain polyamide selected from PA 1010, PA11, PA12, PA1012, polyamide 1212 (PA1212), a mixture thereof or a copolyamide thereof, in particular PA11 and PA12.

Polyamides P1 and P2 may be identical or different but in this latter case, they must thus be weldable. The term “weldable” is as defined in ISO standard 472: 2013 and refers to a method for assembling the softened surface, generally using heat

In one embodiment, polyamide P2 and polyamide P1 are both semi-aromatic polyamides.

Advantageously, semi-aromatic polyamide P2 is identical to semi-aromatic polyamide P1.

In another embodiment, polyamide P2 and polyamide P1 are both aliphatic polyamides.

Advantageously, aliphatic polyamide P2 is identical to aliphatic polyamide P1.

More advantageously, P1 and P2 are identical and selected from a short chain aliphatic polyamide which is polyamide 6 (PA6) and a long chain aliphatic polyamide selected from polyamide 11 (PA11), polyamide 12 (PA12), polyamide 1010 (PA1010), polyamide 1012 (PA1012), polyamide 1212 (PA1212), a mixture thereof or a co-polyamide thereof, in particular PA11 and PA12.

More advantageously, P1 and P2 are identical and selected from PA6, PA11 and PA12.

Regarding the Composite Reinforcement Layer (4)

One or more composite reinforcement layers may be present.

Advantageously, the first reinforcement layer present is wound around the sealing layer (2) and the other layers, if they are present, are wound around each other on top of the first reinforcement layer.

Advantageously, a single reinforcement layer is present and wound around the sealing layer (2).

In one embodiment, each of said layers consists of a composition predominantly comprising at least one polyamide P3.

In one embodiment, the number of reinforcement layers is from 1 to 10, in particular from 1 to 5, especially from 1 to 3.

The term “predominantly” means that said at least one polyamide is present at more than 50% by weight relative to the total weight of the composite matrix.

Advantageously, said at least one predominant polyamide is present at more than 60% by weight, especially at more than 70% by weight, particularly at more than 80% by weight, more particularly greater than or equal to 90% by weight, relative to the total weight of the composition,

Said composition may further comprise impact modifiers and/or additives.

The additives may be chosen from an antioxidant, a heat stabilizer, a UV absorber, a light stabilizer, a lubricant, an inorganic filler, a flame retardant agent, a nucleating agent, a plasticizer, and a dye.

Advantageously, said composition predominantly consists of said polyamide P3j, from 0 to 5% by weight of impact modifier, from 0 to 5% by weight of additives, the sum of the constituents of the composition being equal to 100%.

Said at least one predominant polyamide in each layer may be identical or different.

In one embodiment, a single predominant polyamide is present at least in the composite reinforcement layer wound around the sealing layer (2).

In one embodiment, each reinforcement layer comprises the same type of polyamide P3.

Regarding Polyamide P3

Polyamide P3 is as defined for polyamide P1.

Polyamide P3 may be identical to or different from polyamide P1.

In one embodiment, polyamide P3 and polyamide P1 are both semi-aromatic polyamides.

Advantageously, semi-aromatic polyamide P3 is identical to semi-aromatic polyamide P1.

More advantageously, P1 and P3 are identical and selected from polyamides with a high Tg, in particular having a Tg of at least 90° C., preferably of at least 100° C., more preferentially of at least 110° C., even more preferentially 120° C.

In another embodiment, polyamide P3 and polyamide P1 are both aliphatic polyamides.

Advantageously, aliphatic polyamide P3 is identical to aliphatic polyamide P1.

More advantageously, P1 and P3 are identical and selected from a short chain aliphatic polyamide which is polyamide 6 (PA6) and a long chain aliphatic polyamide selected from polyamide 11 (PA11), polyamide 12 (PA12), polyamide 1010 (PA1010), polyamide 1012 (PA1012), polyamide 1212 (PA1012), a mixture thereof or a co-polyamide thereof, in particular PA11 and PA12.

More advantageously, P1 and P3 are identical and selected from PA6, PA11 and PA12.

In one embodiment, polyamide P3, polyamide P2 and polyamide P1 are all three semi-aromatic polyamides.

Advantageously, semi-aromatic polyamide P3, semi-aromatic polyamide P2 are identical to semi-aromatic polyamide P1.

More advantageously, P1, P2 and P3 are identical and selected from polyamides with a high Tg, in particular having a Tg of at least 90° C., preferably of at least 100° C., more preferentially of at least 110° C., even more preferentially 120° C.

In another embodiment, polyamide P3, polyamide P2 and polyamide P1 are all three aliphatic polyamides.

Advantageously, aliphatic polyamide P3, aliphatic polyamide P2 are identical to aliphatic polyamide P1.

More advantageously, P1, P2 and P3 are identical and selected from a short chain aliphatic polyamide which is polyamide 6 (PA6) and a long chain aliphatic polyamide selected from polyamide 11 (PA11), polyamide 12 (PA12), polyamide 1010 (PA1010), polyamide 1012 (PA1012), polyamide 1212 (PA1012), or a mixture thereof or a co-polyamide thereof, in particular PA11 and PA12.

More advantageously, P1, P2 and P3 are identical and selected from PA6, PA11 and PA12, polyamides with a high Tg, in particular having a Tg of at least 90° C., preferably of at least 100° C., more preferentially of at least 110° C., even more preferentially 120° C.

More advantageously, P1 and P2 are aliphatic polymers, and P3 is a semi-aromatic polymer with a high Tg, in particular having a Tg of at least 90° C., preferably of at least 100° C., more preferentially of at least 110° C., even more preferentially 120° C.

In another embodiment, each of said layers (4) consists of a composition comprising predominantly at least one thermoset polymer P4, especially epoxide-based.
The thermoset polymers are selected from epoxide resins, polyesters and polyurethanes, in particular epoxide or epoxide-based resins.

Advantageously, the number of layers (4) is from 1 to 10, in particular from 1 to 5, especially from 1 to 3, preferentially 1.

The term “predominantly” means that said at least one polymer is present in excess of 50% by weight relative to the total weight of the composition.

Advantageously, said at least one predominant thermoset polymer is present at more than 60% by weight, especially at more than 70% by weight, particularly at more than 80% by weight, more particularly greater than or equal to 90% by weight, relative to the total weight of the composition,

Said composition may further comprise impact modifiers and/or additives.

The additives may be selected from an antioxidant, a heat stabilizer, a UV absorber, a light stabilizer, a lubricant, an inorganic filler, an inorganic filler, a flame retardant, a nucleating agent, a plasticizer, a pigment and a dye.

Advantageously, said composition predominantly consists of said thermoset polymer P4, from 0 to 5% by weight of impact modifier, from 0 to 5% by weight of additives, the sum of the constituents of the composition being equal to 100%.

Said at least one predominant polymer in each layer may be the same or different.

In one embodiment, a single predominant thermoset polymer is present at least in the composite reinforcement layer wound around the sealing layer (2).

In one embodiment, each reinforcement layer comprises the same type of thermoset polymer.

Regarding the Fibrous Material of the Composite Reinforcement Layer (4)

Regarding the fibers making up said fibrous material, they are in particular mineral, organic or plant fibers.

Advantageously, said fibrous material may be sized or unsized.

Said fibrous material can therefore comprise up to 0.1% by weight of an organic material (of thermoset or thermoplastic resin type), referred to as sizing.

The mineral fibers include carbon fibers, glass fibers, basalt or basalt-based fibers, silica fibers, or silicon carbide fibers, for example. The organic fibers include thermoplastic or thermosetting polymer-based fibers, such as semi-aromatic polyamide fibers, aramid fibers or polyolefin fibers, for example. Preferably, they are amorphous thermoplastic polymer-based and have a glass transition temperature Tg higher than the Tg of the polymer or thermoplastic polymer mixture constituting the pre-impregnation matrix when the latter is amorphous, or higher than the Tm of the polymer or thermoplastic polymer mixture constituting the pre-impregnation matrix when the latter is semi-crystalline. Advantageously, they are semi-crystalline thermoplastic polymer-based and have a melting temperature Tm higher than the Tg of the polymer or thermoplastic polymer mixture constituting the pre-impregnation matrix when the latter is amorphous, or higher than the Tm of the polymer or thermoplastic polymer mixture constituting the pre-impregnation matrix when the latter is semi-crystalline. Thus, there is no melting risk for the organic fibers constituting the fibrous material during the impregnation by the thermoplastic matrix of the final composite. The plant fibers include natural linen, hemp, lignin, bamboo, silk, in particular spider silk, sisal, and other cellulose fibers, in particular viscose. These plant fibers can be used pure, treated or coated with a coating layer, in order to facilitate the adherence and impregnation of the thermoplastic polymer matrix.

The fibrous material may also be a fabric, a braid or woven with fibers.

It may also correspond to fibers with support threads.

These component fibers may be used alone or in mixtures. Thus, organic fibers can be mixed with the mineral fibers to be pre-impregnated with thermoplastic polymer powder and to form the pre-impregnated fibrous material.

The organic fiber strands may have several grammages. They can further have several geometries. The component fibers of the fibrous material can further assume the form of a mixture of these reinforcing fibers with different geometries. The fibers are continuous fibers.

Preferably, the fibrous material consists of continuous carbon or glass fibers or or mixtures thereof, in particular carbon fibers. It is used in the form of one roving or several rovings.

Regarding the Method More Specifically

When the adhesion primer comprises an epoxide, for example an epoxide-polyurethane mixture or an epoxide-polyamide P2 mixture, or consists only of an epoxide, the method then comprises a step of crosslinking said epoxide.

The crosslinking step leads to the formation of one or several three-dimensional networks, by chemical or physical means, at the base (3). This then allows the epoxide to be cured on the base.

According to a first variant, said adhesion primer consists of an epoxide, said sealing layer (2) being prepared by rotational molding in a mold, and the crosslinking step is carried out during the rotational molding after prior introduction of said base (3) into the rotational molding mold before the preparation of said sealing layer (2).

In this first variant, said base (3) is covered by at least one layer consisting of an epoxide, by covering using a spray gun, by dipping into the diluted primer, or by covering using a brush and introduced into the rotational molding mold before crosslinking. The thickness of the primer in the form of a dry film before introduction into the rotational molding mold is then from 5 to 20 μm.

Advantageously, a single layer consisting of said epoxide covers the base (3).

The crosslinking is then carried out at the same time as the sealing layer (2) is prepared by heating the polyamide used, especially in the form of powder, and introduced into the rotational molding mold.

Heating is therefore dependent on the melting temperature of the polyamide used.

According to a second variant, said adhesion primer consists of an epoxide, said adhesion primer consists of an epoxide, said sealing layer (2) being prepared by rotational molding in a mold, the crosslinking step being carried out during a pre-firing step before introduction of said base (3) into the rotational molding mold before preparation of said sealing layer (2).

In this second variant, said base (3) is covered by at least one layer consisting of an epoxide by dipping into a fluidized bed, covering using a spray gun or dipping into the diluted primer and introduced into a preheating system, especially a furnace, to carry out the crosslinking before the base is introduced into the preparation mold of said sealing layer (2). The thickness of the primer in the form of a dry film before introduction into the preheating system is then from 8 to 12 μm.

The temperature of the furnace depends on the thickness of the base, on the residence time. To compensate for this, there are crosslinking color guides for the primer.

However, the time during which the base is heated at a high temperature (especially greater than 200° C., in particular approximately equal to 220° C.) must be short, preferably from 4 to 20 minutes.

Advantageously, a single layer consisting of said epoxide covers the base (3).

According to a third variant, said adhesion primer consists of an epoxide, said sealing layer (2) being previously prepared by injection, thermoforming or extrusion-blow molding, said crosslinking being carried out during a pre-firing step before the fastening of said at least one base (3) to said at least one previously prepared sealing layer (2).

In this third variant, said base (3) is covered by at least one layer consisting of an epoxide by dipping into a fluidized bed, covering using a spray gun or dipping into the diluted primer and introduced into a preheating system, especially a furnace, to perform the crosslinking before the base is introduced into the preparation mold of said sealing layer (2). The thickness of the primer in the form of a dry film before introduction into the preheating system is then from 8 to 12 μm.

The fastening of the base to said at least one previously prepared sealing layer (2) is then carried out by welding.

In a preferred manner, the two surfaces to be assembled are heated beyond their respective melting points and brought into contact, this contact is maintained until the 2 surfaces have cooled down again (examples of mirror welding and ultrasonic welding).

Another preferred method enables melting when the two materials are in contact (examples of friction welding and laser welding). It is also possible to only melt one of the 2 surfaces before contact is made.

The temperature of the furnace depends on the thickness of the base, on the residence time. To compensate for this, there are crosslinking color guides for the primer.

However, the time during which the base is heated at a high temperature (especially greater than 200° C., in particular approximately equal to 220° C.) must be short, preferably from 4 to 20 minutes.

Advantageously, a single layer consisting of said epoxide covers the base (3).

According to a fourth variant, said adhesion primer consists of an epoxide, said sealing layer (2) being prepared by injection, thermoforming or extrusion, said crosslinking being carried out during a pre-firing step before the fastening of said at least one base (3) to said at least one sealing layer.

In this fourth variant, said sealing layer (2) is not prepared in a rotational molding mold but by injection, thermoforming or extrusion

The temperature of the furnace depends on the thickness of the base, on the residence time. To compensate for this, there are crosslinking color guides for the primer.

However, the time during which the base is heated at a high temperature (especially greater than 200° C., in particular approximately equal to 220° C.) must be short, preferably from 4 to 20 minutes.

Advantageously, a single layer consisting of said epoxide covers the base (3).

According to a fifth variant, said adhesion primer consists of an epoxide, the crosslinking step being carried out during a pre-firing step and said base heated and covered by a crosslinked epoxide is then dipped into a fluidized bed of polyamide P2 or a powder of polyamide P2 is non-electrostatically sprayed before the fastening of said at least one base (3) to said at least one previously prepared sealing layer (2).

In this fifth variant, said base (3) is covered by at least one layer consisting of an epoxide by covering using a spray gun or by dipping into the diluted primer and introduced into a preheating system, especially a furnace, to perform the crosslinking before the base is inserted into the preparation mold of said sealing layer (2). The thickness of the primer in the form of a dry film before introduction into the preheating system is then from 5 to 20 μm.

The temperature of the furnace depends on the thickness of the base, on the residence time. To compensate for this, there are crosslinking color guides for the primer.

However, the time during which the base is heated at a high temperature must be sufficient to enable good crosslinking.

Advantageously, a single layer consisting of said epoxide covers the base (3).

Said base can thus be fastened to the sealing layer (2) after its preparation or in a rotational molding mold for the preparation of said sealing layer (2).

According to a sixth variant, said at least one metal base (3) is covered by at least one layer (a) consisting of a composition comprising at least one adhesion primer consisting of an epoxide covered with a layer (b) consisting of a composition comprising at least one polyamide P2 in powder form, said base being previously covered with an epoxide then said polyamide P2 in powder form being applied to said base (3), said base being then passed into a furnace to crosslink said epoxide and enable the melting of polyamide P2.

In this sixth variant, the adhesion primer and polyamide P2 are present on the base before the crosslinking and therefore before the introduction of said base into the furnace in order to crosslink the epoxide. Said base (3) is covered by at least one layer (a) consisting of an epoxide, by covering using a spray gun or by dipping into the diluted primer then said polyamide P2 in powder form is applied by electrostatic spraying, by stoved powder coating or by dipping into a fluidized bed on said base (3), said base then being passed into a furnace to crosslink said epoxide and enable the melting of polyamide P2.

Advantageously, the layer (b) consisting of a composition comprising at least one polyamide P2 in powder form has a thickness of from 100 μm to 1500 μm.

In one embodiment, said thickness is from 50 to 200 μm, said polyamide P2 in powder form being applied by electrostatic spraying.

In another embodiment, said thickness is from 150 μm to 1500 μm, preferably from 200 μm to 1000 μm, said polyamide P2 in powder form being applied by stoved powder coating or by dipping into a fluidized bed.

The temperature of the furnace depends on the thickness of the base, on the residence time. The coating P2 must appear completely melted at the outlet of the furnace.

However, the time during which the base is heated at a high temperature (especially greater than 200° C., in particular approximately equal to 220° C.) must be short, preferably from 4 to 20 minutes.

Advantageously, a single layer (a) consisting of said epoxide and a single layer (b) consisting of said polyamide P2 covers the base (3).

According to a seventh variant, said at least one metal base (3) is covered by at least one layer (a) consisting of a composition comprising at least one adhesion primer consisting of a mixture of a polyamide P2 and an epoxide, said base then being passed into a furnace in order to crosslink said epoxide and enable the melting of polyamide P2.

In this seventh variant, the primer therefore consists of a mixture of polyamide P2 and epoxide, as defined above and especially of epoxide particles dispersed in a polyamide powder as defined above.

Said base (3) is covered by at least one layer (a) consisting of a mixture of polyamide P2 and epoxide, as defined above and especially of epoxide particles dispersed in a polyamide powder as defined above by electrostatic spraying, said base then being passed into a furnace to crosslink said epoxide and enable the melting of polyamide P2.

The temperature of the furnace depends on the thickness of the base, on the residence time. The coating P2 must appear completely melted at the outlet of the furnace.

However, the time during which the base is heated at a high temperature (especially greater than 200° C., in particular approximately equal to 220° C.) must be short, preferably from 4 to 20 minutes.

Advantageously, a single layer (a) consisting of said mixture of epoxide and polyamide P2 covers the base (3).

In one embodiment, the method as defined above for the fifth, sixth and seventh variants, characterized in that said sealing layer (2) is previously prepared by rotational molding, by injection, thermoforming or extrusion blow molding, said crosslinking being carried out during a pre-firing step before the fastening of said at least one base (3) to said at least one previously prepared sealing layer (2).

In another embodiment, the method as defined above for variants 1 to 7 is characterized in that the tank comprises at least one composite reinforcement layer (4) consisting of a fibrous material in the form of continuous fibers impregnated by a composition predominantly comprising at least one epoxide-based thermoset polymer.

In another embodiment, the method as defined above for variants 1 to 7, is characterized in that the tank comprises at least one composite reinforcement layer (4) consisting of a fibrous material in the form of continuous fibers impregnated by a composition predominantly comprising at least one polyamide P3.

Advantageously, said at least one composite reinforcement layer (4) is wound around the layer (2).

### DESCRIPTION OF THE FIGURES

FIG. 1 shows an example of a hydrogen tank (1) comprising a sealing layer (2), a base (3), a composite reinforcement layer (4) and an opening (5) and the joining (6) of the base (3) with the sealing layer (2).

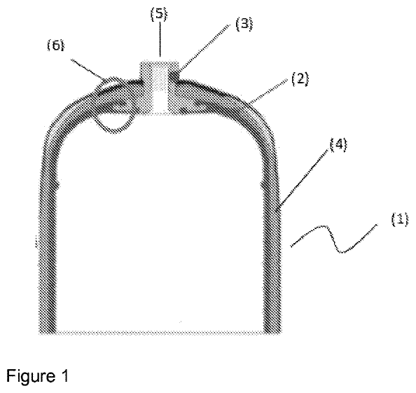

### EXAMPLES

### Example 1: Preparation of a Tank Comprising a Sealing Layer (2) Made from PA 11, a Metal Base (3) Covered with Epoxy Primer and a Composite Reinforcement Layer Made from Carbon Fibers with an Epoxy Matrix

The base is shot-peened at the contact zone with the sealing layer. 2 hours after this step, a primer layer, supplied by Arkema under the name Primgreen® LAT 12035, is applied by spraying in such a way a homogeneous white color to the eye. It is then left to dry in a ventilated location until the white color disappears.

This base is then introduced into a furnace at 270° C. for 30 minutes. Upon exiting the furnace, a brown color is visible at the application zones of the primer; which color is defined in the procedures supplied by Arkema. Polyamide powder, supplied by Arkema, under the reference Rilsan® PA11 T nat BHV2, is sprayed onto the hot base in order to achieve a thickness of approximately 400 μm. The base is then left to cool, until a temperature of less than 50° C. is reached.

The base thus coated is then introduced into a rotational molding mold. Powder of PA 11, sold by Arkema under the name Roto 11 natural, is introduced into the mold. The temperature inside the mold is monitored during the rotational molding step. This mold is heated, whilst being rotated, until the temperature inside the mold reaches 220° C. Heating is then stopped, and the mold cooled.

The method is stopped when a temperature of 70° C. is reached. The heating/cooling cycle lasts 1 hour.

The sealing layer is then covered by a 2 cm thick composite containing carbon fibers and an epoxy resin. The fibers are unwound from the spools on which they are supplied and wound around the sealing layer. Between the spools and the tank being constructed, they pass through a liquid epoxy bath to be impregnated with this resin. Once the 2 cm thickness is achieved in any part of the tank (except at the openings), the tank is introduced into an autoclave at 80° C. for 8 h.

### Comparative Example 2: Preparation of a Tank Comprising a PA 11 Sealing Layer (2), a Metal Base (3) without Epoxide and a Composite Reinforcement Layer Made from Carbon Fibers with an Epoxy Matrix

The same test as in example 1 is carried out, with the exception of the following steps which are not carried out:
After shot-peening, no primer is applied
The drying step specific to the primer is not carried out

The method previously disclosed resumes with the heating of the base in a furnace, and spraying of the PA11 powder.

Adhesion results with the two different bases.

Following these 2 tank preparations, the quality of the adhesion on the base is assessed. To simulate aging, the tank is cut around the base, leaving 2 cm around the entire base. The largest coated surface of the base (internal face of the tank) is then marked; a diagonal cross is carved therein, by cutting the layer of PA11 until the metal is reached. The diagonal cross is located in the vicinity of the center of this largest surface. The part is then introduced into a climate chamber to perform a salt fog test for 2000 h.

At the end of the test, the adhesion quality is assessed by removing the surface of PA 11 no longer adhering to the base (by applying a knife blade under the surface, in the center of the cross, the layer of PA11 must be able to be lifted with just the force required to deform the layer of PA 11). The maximum delamination from the center of the cross is measured.
For the base prepared with primer (example 1), the greatest delamination distance reaches 8 mm.
For the base prepared without primer (example 2), the greatest delamination distance reaches the edge of the base, of the order of 4 cm

1. A method for preparing a hydrogen tank comprising at least one sealing layer consisting of a composition comprising at least one polyamide P1, and at least one base to provide at least one opening in said tank, wherein said method comprises:
providing at least one base, said at least one base being covered by at least one layer consisting of a composition comprising at least one adhesion primer,
preparing said at least one sealing layer,
fastening said at least one base to said at least one sealing layer.

2. The method according to claim 1, wherein said at least one base is metal.

3. The method according to claim 2, wherein said at least one base is degreased and/or stripped/shot-peened before being covered by said at least one layer consisting of a composition comprising at least one adhesion primer.

4. The method according to claim 1, wherein said adhesion primer is in liquid or solid form.

5. The method according to claim 1, wherein said adhesion primer is selected from an aromatic or aliphatic polyurethane, an epoxide, a mixture of an aromatic or aliphatic polyurethane and epoxide, and a mixture of a polyamide P2 and epoxide.

6. The method according to claim 5, wherein said at least one adhesion primer is an epoxide or a mixture of polyester and epoxide.

7. The method according to claim 6, wherein said at least one base is metal and covered by at least one layer consisting of a composition comprising at least one adhesion primer consisting of an epoxide is then covered by a layer consisting of a composition comprising at least one polyamide P2 in powder form.

8. The method according to claim 7, wherein the layer consisting of a composition comprising at least one polyamide P2 has a thickness of from 50 μm to 1500 μm.

9. The method according to claim 5, wherein said composition comprises an adhesion primer consisting of a mixture of at least one epoxide and at least one polyamide P2 and the thickness of the layer is from 1 to 200 μm.

10. The method according to claim 7, wherein said at least one polyamide P2 is a long chain polyamide selected from PA 1010, PA11, PA12, PA1012, PA1212, a mixture thereof or a copolyamide thereof.

11. The method according to claim 6, wherein it comprises a step of crosslinking said epoxide.

12. The method according to claim 11, wherein said adhesion primer consists of an epoxide, said sealing layer being prepared by rotational molding in a mold, and the crosslinking step is carried out during the rotational molding after prior introduction of said base into the rotational molding mold before the preparation of said sealing layer.

13. The method according to claim 11, wherein said adhesion primer consists of an epoxide, said sealing layer being prepared by rotational molding in a mold, the crosslinking step being carried out during a pre-firing step before introduction of said base into the rotational molding mold before preparation of said sealing layer.

14. The method according to claim 11, wherein said adhesion primer consists of an epoxide, said sealing layer being previously prepared by injection, thermoforming or extrusion blow molding, said crosslinking being carried out during a pre-firing step before the fastening of said at least one base to said at least one previously prepared sealing layer.

15. The method according to claim 11, wherein said adhesion primer consists of an epoxide, said sealing layer being prepared by injection, thermoforming or extrusion, said crosslinking being carried out during a pre-firing step before the fastening of said at least one base to said at least one sealing layer.

16. The method according to claim 11, wherein said adhesion primer consists of an epoxide, the crosslinking step being carried out during a pre-firing step and said base heated and covered by crosslinked epoxide is then dipped into a fluidized bed of polyamide P2 or a polyamide powder P2 is sprayed before the fastening of said at least one base to said at least one previously prepared sealing layer.

17. The method according to claim 11, wherein said at least one metal base is covered by at least one layer consisting of a composition comprising at least one adhesion primer consisting of an epoxide covered with a layer consisting of a composition comprising at least one polyamide P2 in powder form, said base being previously covered with an epoxide then said polyamide P2 in powder form being applied to said base, said base being then passed into a furnace in order to crosslink said epoxide and enable the melting of the polyamide P2.

18. The method according to claim 11, wherein said at least one metal base is covered by at least one layer consisting of a composition comprising at least one adhesion primer consisting of a mixture of a polyamide P2 and an epoxide, said base then being passed into a furnace in order to crosslink said epoxide and enable the melting of polyamide P2.

19. The method according to claim 16, wherein said sealing layer is prepared beforehand by rotational molding, by injection, thermoforming or extrusion blow molding, said crosslinking being carried out during a pre-firing step before the fastening of said at least one base to said at least one previously prepared sealing layer.

20. The method according to claim 12, wherein the tank comprises at least one composite reinforcement layer consisting of a fibrous material in the form of continuous fibers impregnated by a composition predominantly comprising at least one thermoset polymer P4, especially epoxide-based.

21. The method according to claim 12, wherein the tank comprises at least one composite reinforcement layer consisting of a fibrous material in the form of continuous fibers impregnated by a composition predominantly comprising at least one polyamide P3.

22. The method according to claim 20, wherein said at least one composite reinforcement layer is wound around the layer.

23. The method according to claim 20, wherein polyamide P3j is an aliphatic polyamide.

24. The method according to claim 1, wherein said at least one polyamide P1 is a semi-aromatic copolyamide comprising at least two distinct units A and XY of formula A/XY, wherein:
A is a repeating unit obtained by polycondensation:
of at least one C9 to C18, amino acid, or
of at least one C9 to C18, lactam, or
of at least one C4-C36 Ca diamine, with at least one C4-C36 Cb dicarboxylic acid,
XY is a repeating unit obtained from the polycondensation of at least one C9 to C18 linear aliphatic diamine (X) and of at least one aromatic dicarboxylic acid (Y).

25. The method according to claim 1, wherein said at least one polyamide P1 is a short chain aliphatic polyamide having an average number of carbon atoms per nitrogen atom of from 4 to 8.5, or a long chain polyamide having an average number of carbon atoms per nitrogen atom greater than 8.5.

26. The method according to claim 25, wherein the short chain aliphatic polyamide is polyamide 6 and the long chain aliphatic polyamide is selected from polyamide 11, polyamide 12, polyamide 1010, polyamide 1012, polyamide 1212, or a mixture thereof or a copolyamide thereof.

27. The method according to claim 25, wherein said at least one aliphatic polyamide P1 is selected from PA6, PA11 and PA12.
